(19) United States
(12) Patent Application Publication
(10) Pub. No.: US 2013/0174024 A1
(43) Pub. Date: Jul. 4, 2013

(54) METHOD AND DEVICE FOR CONVERTING DOCUMENT FORMAT

(71) Applicants: Guofeng XING, Beijing (CN); Zhensheng He, Beijing (CN)

(72) Inventors: Guofeng XING, Beijing (CN); Zhensheng He, Beijing (CN)

(21) Appl. No.: 13/731,717

(22) Filed: Dec. 31, 2012

(30) Foreign Application Priority Data
Dec. 30, 2011 (CN) 201110456098.8

(51) Int. Cl. G06F 17/21

(52) U.S. Cl. CPC G06F 17/211
USPC 715/249

(57) ABSTRACT

This application provides methods and devices for converting a document format. The method may comprise typesetting a flow document and extracting first logical structure information of a document entity from the typeset flow document. The method may also comprise mapping a layout element associated with the document entity to a framing box corresponding to the first logical structure information. In addition, the method may comprise converting the layout element mapped to the framing box into a description form of second logical structure information associated with a target document format.

### CROSS REFERENCE OF RELATED APPLICATION

This application claims the benefits of priority to Chinese Patent Application No. 201110456098.8, filed on Dec. 30, 2011, the entire contents of which are incorporated herein by reference.

### TECHNICAL FIELD

The present disclosure relates to the field of communication technology, and more particularly, to methods and devices for converting document formats.

### BACKGROUND

In digital publishing and electronic documents processing field, a flow document can be converted into a fixed-layout document through virtual printing. In the process of virtual printing, however, some structure information of the flow document, such as paragraphs, title, columns, cross-pages, table formats, formula formats, etc., may be lost. As a result, the converted fixed-layout document may not retain all structure information available in the original flow document. When a user reads such a fixed-layout document on a mobile device such as a mobile phone, an e-book, a tablet, etc., the layout of the fixed-layout document cannot be automatically adjusted to fit the screen of the mobile device. For example, paragraphs may be out of order, a table or a formula may be broken up into pieces. Therefore, it is desirable to provide a method and a device to effectively convert document format while retaining structure information.

### SUMMARY

Some embodiments involve a method for converting a document format. The method may comprise typesetting a flow document and extracting first logical structure information of a document entity from the typeset flow document. The method may also comprise mapping a layout element associated with the document entity to a framing box corresponding to the first logical structure information. In addition, the method may comprise converting the layout element mapped to the framing box into a description form of second logical structure information associated with a target document format.

Other embodiments involve a device for converting a document format. The device may include a typesetting module configured to typeset a flow document and an extracting module configured to extract first logical structure information of a document entity from the typeset flow document. The device may also include a mapping module configured to map a layout element associated with the document entity to a framing box corresponding to the first logical structure information. In addition, the device may include a converting module configured to convert the layout element mapped to the framing box into a description form of second logical structure information associated with a target document format.

The preceding summary and the following detailed description are exemplary only and do not limit the scope of the claims.

### BRIEF DESCRIPTION OF THE DRAWINGS

The accompanying drawings, which are incorporated in and constitute a part of this specification, in connection with the description, illustrate various embodiments and exemplary aspects of the disclosed embodiments. In the drawings:

FIG. 1 is a flow chart illustrating an exemplary method for converting document format, consistent with some disclosed embodiments;

FIG. 2 is a flow chart illustrating an exemplary method for extracting a first logical structure information of a paragraph, consistent with some disclosed embodiments;

FIG. 3 is a flow chart illustrating an exemplary method for extracting a first logical structure information of a paragraph, consistent with some disclosed embodiments;

FIG. 4 is a flow chart illustrating an exemplary method for extracting a first logical structure information of a table, consistent with some disclosed embodiments; and

FIG. 5 is a diagram illustrating an exemplary device for converting document format, consistent with some disclosed embodiments.

### DESCRIPTION OF THE EXEMPLARY EMBODIMENTS

Reference will now be made in detail to exemplary embodiments, examples of which are illustrated in the accompanying drawings. When appropriate, the same reference numbers are used throughout the drawings to refer to the same or like parts.

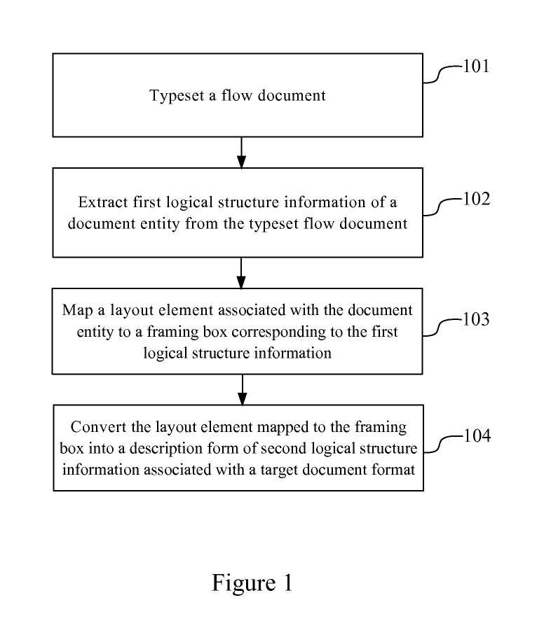

FIG. 1 is a flow chart illustrating an exemplary method for converting document format, consistent with some disclosed embodiments. The method shown in FIG. 1 comprises a series of steps, and one or more of the steps may be performed by executing computer programs using one or more processors. For example, a computer may store computer programs in its storage media which when executed would perform the method as shown in FIG. 1. Further, one or more of the steps may be optional.

In step 101, a flow document, such as an original flow document to be converted, may be typeset using a typesetting tool.

In step 102, first logical structure information of a document entity may be extracted from the typeset flow document.

In step 103, the method may comprise mapping a layout element associated with the document entity to a framing box (e.g., a rectangular box) corresponding to the first logical structure information.

In step 104, the method may comprise converting the layout element mapped to the framing box into a description form of second logical structure information associated with a target document format.

In some embodiments, a flow document may contain original logical structure information. The flow document may be typeset or formatted, and the original logical structure information may be converted into the first logical structure information containing location information and/or attribute information. The flow document may include various document entities, such as title, paragraph, table, formula, image, composite entity, etc. After the flow document is typeset using a typesetting tool, each document entity may include the location information and/or attribute information. The first logical structure information of each document entity may also include the location information and/or attribute information. For example, when the document entity includes a paragraph, the first logical structure information of the paragraph may include the following information: whether the paragraph spans multiple pages, whether the paragraph includes multiple columns (e.g., whether the paragraph is arranged in a multiple-column format), whether the paragraph includes a title, whether the first line of the paragraph is indented, the specific alignment manner, the location field of the paragraph, etc.

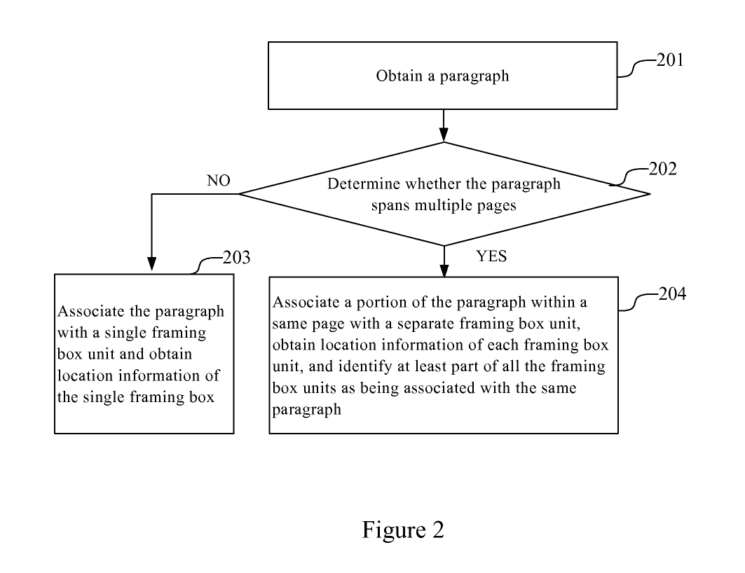

In some embodiments, the first logical structure information of a document entity may be extracted from the typeset flow document to obtain the specific structure of the document. For example, when the document entity includes a paragraph, extracting the first logical structure information of a document entity from the typeset flow document may comprise the followings steps, as shown in FIG. 2.

In step 201, a current paragraph may be obtained.

In step 202, the method may include determining whether the paragraph spans multiple pages. When the paragraph does not span multiple pages (“NO” branch), step 203 may be executed. When the paragraph spans multiple pages (“YES” branch), step 204 may be executed. In some embodiments, if the page number associated with the first character/word of the paragraph is the same as the page number associated with the last character/word of the paragraph, it may indicate that the paragraph does not span multiple pages. On the other hand, if the page numbers are different, it may indicate that the paragraph spans multiple pages.

In step 203, the method may comprise associating the paragraph with a single framing box unit and obtaining location information of the single framing box. The location information may be stored.

In step 204, the method may comprise associating a portion of the paragraph within a same page with a separate framing box unit, obtaining location information of each framing box unit, and identifying at least part of all the framing box units as being associated with the same paragraph. The location information of each framing box unit may be stored. The attribute information of the paragraph, such as title, paragraph format, etc., can also be obtained.

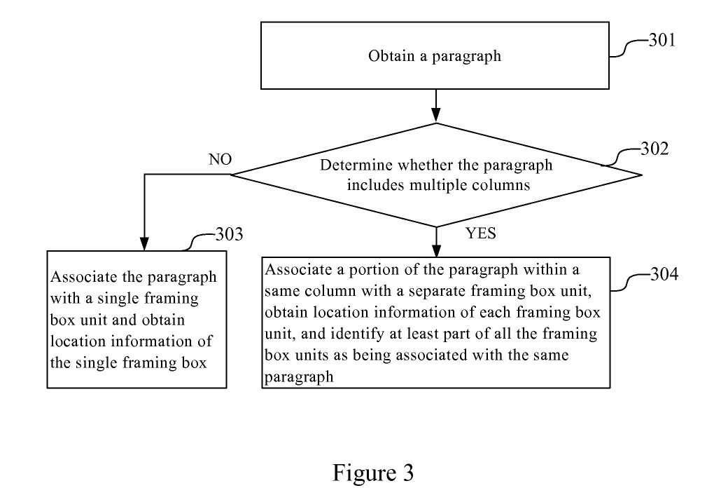

In some embodiments, when the document entity includes a paragraph, extracting the first logical structure information of a document entity from the typeset flow document may comprise the followings steps, as shown in FIG. 3.

In step 301, a current paragraph may be obtained.

In step 302, the method may include determining whether the paragraph includes multiple columns (e.g., having a multi-column structure). When the paragraph does not include multiple columns (“NO” branch), step 303 may be executed. When the paragraph includes multiple columns (“YES” branch), step 304 may be executed. In some embodiments, if the number of text columns in the paragraph is larger than one, it may indicate that the paragraph has multiple columns. On the other hand, if the number of text columns in the paragraph is equal to one, it may indicate that the paragraph does not have multiple columns.

In step 303, the method may comprise associating the paragraph with a single framing box unit and obtaining location information of the single framing box. The location information may be stored.

In step 304, the method may comprise associating a portion of the paragraph within a same column with a separate framing box unit, obtaining location information of each framing box unit, and identifying at least part of all the framing box units as being associated with the same paragraph. The location information of each framing box unit may be stored. The attribute information of the paragraph, such as title, paragraph format, etc., can also be obtained.

The order of determining whether a paragraph spans multiple pages and determining whether the paragraph includes multiple columns may be flexible. In some embodiments, whether the paragraph includes multiple columns may be determined first, followed by the determination of whether a paragraph spans multiple pages.

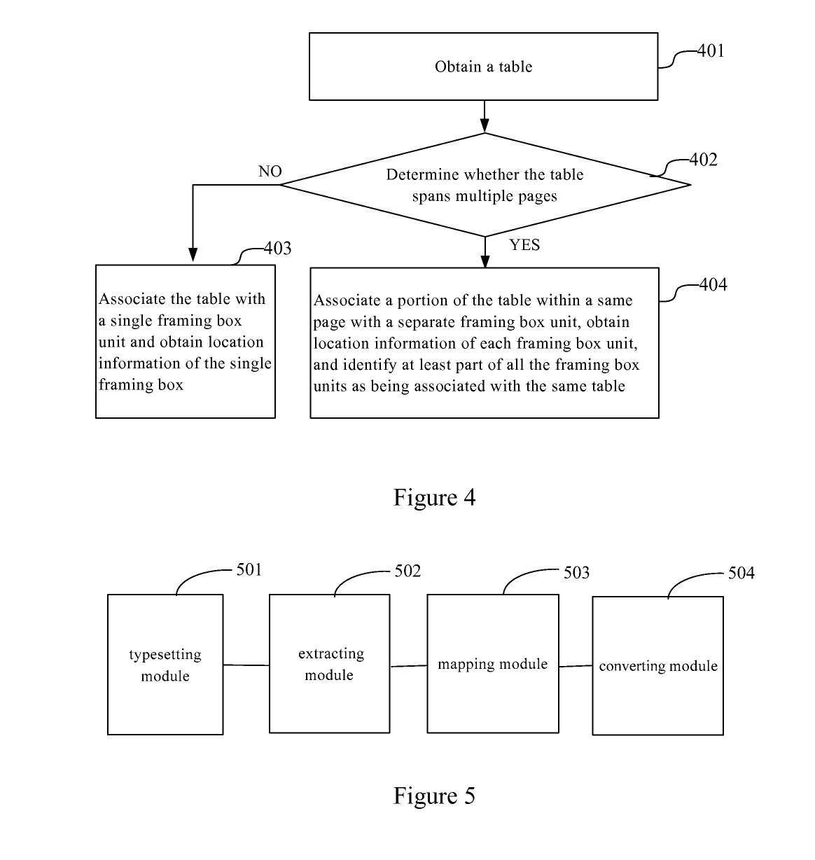

When the document entity includes a table, extracting the first logical structure information of a document entity from the typeset flow document may comprise the followings steps, as shown in FIG. 4.

In step 401, a current table may be obtained.

In step 402, the method may include determining whether the table spans multiple pages. When the table does not span multiple pages (“NO” branch), step 403 may be executed. When the table spans multiple pages (“YES” branch), step 404 may be executed. In some embodiments, if the page number associated with the first unit grid/cell of the table is the same as the page number associated with the last unit grid/cell of the table, it may indicate that the table does not span multiple pages. On the other hand, if the page numbers are different, it may indicate that the table spans multiple pages.

In step 403, the method may comprise associating the table with a single framing box unit and obtaining location information of the single framing box. The location information may be stored.

In step 404, the method may comprise associating a portion of the table within a same page with a separate framing box unit, obtaining location information of each framing box unit, and identifying at least part of all the framing box units as being associated with the same table. The location information of each framing box unit may be stored. The attribute information of the table, such as title, table format, etc., can also be obtained.

After obtaining the first logical structure information of one or more document entities, a plurality of framing boxes (e.g., rectangular boxes) may be constructed. Content may be mapped to the corresponding framing box. In some embodiments, one or more layout elements in a document entity of the typeset flow document can be obtained. The one or more layout elements may be mapped to a framing box unit having corresponding location information in the framing box based on location information of the layout element. The location information of the layout element (such as a character) can be obtained to determine which framing box unit the layout element should be located in. A mapping relationship between the layout element and the framing box unit having the corresponding location information can be established.

In some embodiments, the layout element mapped to each framing box or framing box unit may be converted into a description form of second logical structure information associated with a target document format. The description form can be stored. The description form may be a fixed-layout document form or other document forms.

In some embodiments, a document format including fixed-layout format information and flow format information can be generated after the format conversion. Such a document format may meet requirements for displaying on both computer screens and mobile device screens. Moreover, such a document format can meet different requirements for displaying on different devices, which may reduce the cost for converting document format.

FIG. 5 is a diagram illustrating an exemplary device for converting document format, consistent with some disclosed embodiments. As shown in FIG. 5, the device may comprise a typesetting module 501 configured to typeset a flow document; an extracting module 502 configured to extract first logical structure information of a document entity from the typeset flow document; a mapping module 503 configured to map a layout element associated with the document entity to a framing box corresponding to the first logical structure information; and a converting module 504 configured to convert the layout element mapped to the framing box into a description form of second logical structure information associated with a target document format.

In some embodiments, the flow document may include original logical structure information. Typesetting module 501 may be further configured to convert the original logical structure information into the first logical structure information, the first logical structure information including at least one of location information or attribute information.

In some embodiments, when the document entity includes a paragraph or a table, extracting module 502 may be further configured to: obtain the paragraph or the table; determine whether the paragraph or the table spans multiple pages; when the paragraph or the table does not span multiple pages, associate the paragraph or the table with a single framing box unit and obtaining location information of the single framing box; and when the paragraph or the table spans multiple pages: associate a portion of the paragraph or the table within a same page with a separate framing box unit; obtain location information of each framing box unit; and identify at least part of all the framing box units as being associated with the same paragraph or the same table.

In some embodiments, when the document entity includes a paragraph, extracting module 502 may be further configured to: obtain the paragraph; determine whether the paragraph includes multiple columns; when the paragraph does not include multiple columns, associate the paragraph with a single framing box unit and obtaining location information of the single framing box; and when the paragraph includes multiple columns: associate a portion of the paragraph within a same column with a separate framing box unit; obtain location information of each framing box unit; and identify at least part of all the framing box units as being associated with the same paragraph.

In some embodiments, mapping module 503 may be further configured to: obtain the layout element; and map the layout element to a framing box unit having corresponding location information in the framing box based on location information of the layout element.

Embodiments disclosed in this disclosure may be a method, a system, or a computer readable medium. Therefore, embodiments may be implemented as full hardware, full software, or a combination thereof. In addition, embodiments may be implemented as a computer program product embodied on one or more computer readable media (comprising but not limited to disk storage, CD-ROM, optical memory and the like) containing a computer readable program code.

Embodiments have been described with reference to the flowchart and/or block diagrams of the method, the device (the system), and the computer readable medium encoded with computer program product. Each flow and/or block of the flowchart and/or block diagram and the combination thereof can be implemented by computer program instructions. Such computer program instructions can be provided to a general computer, a specified computer, an embedded processor or processors of other programmable data processing apparatus to generate a machine, such that a device is generated via the instructions executed on the computer or processor of other programmable data processing apparatus and the device is configured to implement the specific function of one or more flows in the flowchart and/or one or more blocks in the block diagram.

Such computer program instructions can also be stored in a computer readable memory which can direct the computer or other programmable data processing apparatus work in a particular way, such that the instructions stored in the computer readable memory generate manufacture comprising command device which is configured to implement the specific function of one or more flows in the flowchart and/or one or more blocks in the block diagram.

Such computer program instructions can also be loaded on the computer or other programmable data processing apparatus, such that a series of operation steps can be executed on the computer or other programmable data processing apparatus to generate a computer implemented processing so as to provide the progress which can implement the specific function of one or more flows in the flowchart and/or one or more blocks in the block diagram.

In the foregoing descriptions, various aspects, steps, or components are grouped together in a single embodiment for purposes of illustrations. The disclosure is not to be interpreted as requiring all of the disclosed variations for the claimed subject matter. The following claims are incorporated into this Description of the Exemplary Embodiments, with each claim standing on its own as a separate embodiment of the disclosure.

Moreover, it will be apparent to those skilled in the art from consideration of the specification and practice of the present disclosure that various modifications and variations can be made to the disclosed systems and methods without departing from the scope of the disclosure, as claimed. Thus, it is intended that the specification and examples be considered as exemplary only, with a true scope of the present disclosure being indicated by the following claims and their equivalents.

1. A method, implemented by a computer, for converting a document format, comprising:
typesetting a flow document;
extracting, by the computer, first logical structure information of a document entity from the typeset flow document;
mapping, by the computer, a layout element associated with the document entity to a framing box corresponding to the first logical structure information; and
converting, by the computer, the layout element mapped to the framing box into a description form of second logical structure information associated with a target document format.

2. The method according to claim 1, wherein the flow document includes original logical structure information, and typesetting the flow document further comprises:
converting the original logical structure information into the first logical structure information, the first logical structure information including at least one of location information or attribute information.

3. The method according to claim 1, wherein the document entity includes a paragraph or a table, and extracting the first logical structure information further comprises:
obtaining the paragraph or the table;
determining whether the paragraph or the table spans multiple pages;
when the paragraph or the table does not span multiple pages, associating the paragraph or the table with a single framing box unit and obtaining location information of the single framing box; and
when the paragraph or the table spans multiple pages:
associating a portion of the paragraph or the table within a same page with a separate framing box unit;
obtaining location information of each framing box unit; and
identifying at least part of all the framing box units as being associated with the same paragraph or the same table.

4. The method according to claim 3, further comprising obtaining attribute information of the paragraph or the table.

5. The method according to claim 1, wherein the document entity includes a paragraph, and extracting the first logical structure information further comprises:
obtaining the paragraph;
determining whether the paragraph includes multiple columns;
when the paragraph does not include multiple columns, associating the paragraph with a single framing box unit and obtaining location information of the single framing box; and
when the paragraph includes multiple columns:
associating a portion of the paragraph within a same column with a separate framing box unit;
obtaining location information of each framing box unit; and
identifying at least part of all the framing box units as being associated with the same paragraph.

6. The method according to claim 1, wherein mapping the layout element associated with the document entity to the framing box corresponding to the first logical structure information comprises:
obtaining the layout element; and
mapping the layout element to a framing box unit having corresponding location information in the framing box based on location information of the layout element.

7. A device for converting a document format, comprising:
a typesetting module configured to typeset a flow document;
an extracting module configured to extract first logical structure information of a document entity from the typeset flow document;
a mapping module configured to map a layout element associated with the document entity to a framing box corresponding to the first logical structure information; and
a converting module configured to convert the layout element mapped to the framing box into a description form of second logical structure information associated with a target document format.

8. The device according to claim 7, wherein the flow document includes original logical structure information, and the typesetting module is further configured to:
convert the original logical structure information into the first logical structure information, the first logical structure information including at least one of location information or attribute information.

9. The device according to claim 7, wherein the document entity includes a paragraph or a table, and the extracting module is further configured to:
obtain the paragraph or the table;
determine whether the paragraph or the table spans multiple pages;
when the paragraph or the table does not span multiple pages, associate the paragraph or the table with a single framing box unit and obtaining location information of the single framing box; and
when the paragraph or the table spans multiple pages:
associate a portion of the paragraph or the table within a same page with a separate framing box unit;
obtain location information of each framing box unit; and
identify at least part of all the framing box units as being associated with the same paragraph or the same table.

10. The device according to claim 7, wherein the document entity includes a paragraph, and the extracting module is further configured to:
obtain the paragraph;
determine whether the paragraph includes multiple columns;
when the paragraph does not include multiple columns, associate the paragraph with a single framing box unit and obtaining location information of the single framing box; and
when the paragraph includes multiple columns:
associate a portion of the paragraph within a same column with a separate framing box unit;
obtain location information of each framing box unit; and
identify at least part of all the framing box units as being associated with the same paragraph.

11. The device according to claim 7, wherein the mapping module is further configured to:
obtain the layout element; and
map the layout element to a framing box unit having corresponding location information in the framing box based on location information of the layout element.
